(19) United States
(12) Patent Application Publication
(10) Pub. No.: US 2020/0263469 A1
(43) Pub. Date: Aug. 20, 2020

(54) Linear Damper

(71) Applicant: ILLINOIS TOOL WORKS INC., Glenview, IL (US)

(72) Inventors: Michael A. Tyler, Mokena, IL (US); Steven L. Bivens, Kankakee, IL (US); Karly R. Miller, Orland Park, IL (US); Daniel Lindsey, Tinley Park, IL (US)

(21) Appl. No.: 16/790,975

(22) Filed: Feb. 14, 2020

Related U.S. Application Data
(60) Provisional application No. 62/807,290, filed on Feb. 19, 2019.

(51) Int. Cl. E05F 1/10; F16F 15/12; F16F 15/123

(52) U.S. Cl. CPC E05F 1/105; F16F 15/1204; F16F 15/123; F16F 2230/007; F16F 2232/08; E05Y 2201/426; F16F 2238/026; E05Y 2900/538; E05Y 2201/474; E05Y 2201/722; E05Y 2201/64; F16F 2236/04

(57) ABSTRACT

A linear damper includes a rack, a carriage, a gear assembly, and a spring. The rack includes a connector. The carriage is slidably engaged with the rack. The gear assembly is between the carriage and the rack. The spring is secured to the rack to selectively urge the carriage away from the connector.

### RELATED APPLICATIONS

The present application is a non-provisional application and claims priority to U.S. Provisional Application Ser. No. 62/807,290 filed on Feb. 19, 2019, which is incorporated by reference in its entirety herein.

### FIELD OF THE DISCLOSURE

This disclosure relates generally to motion control devices and, more particularly, to a linear damper.

### BACKGROUND

In recent years, dampers have been developed to slow and/or control movement of components relative to one another. For example, vehicles are often equipped with various pivoting assemblies (e.g., hatches, cargo doors, glove boxes, center console lids, hoods, etc.). The components of pivoting assemblies are connected to rotate relative to one another and one or more dampers are connected to the components to regulate the rate at which they rotate.

Certain known damper assemblies are configured to damp the relative movement of components that pivot via gravity. When a lower component (e.g., a glove box door) is released to pivot relative to an upper component (e.g., a dashboard), the damper slows the falling rotation of the lower component.

However, these known damper assemblies provide no assistance to start movement of a first component relative to a second component in a pivoting assembly where the first component is not arranged to pivotably fall away from the second component.

Therefore, a need exists for a damper assembly that provides assistance to initially start and subsequently control movement of pivoting components relative to one another.

### SUMMARY

In one aspect, a linear damper is disclosed, which includes a rack, a carriage, a gear assembly, and a spring. The rack includes a connector. The carriage is slidably engaged with the rack. The gear assembly is between the carriage and the rack. The spring is secured to the rack to selectively urge the carriage away from the connector.

In another aspect, a linear damper is disclosed, which includes a rack, a carriage, a gear assembly, and a spring. The rack includes a gear teeth set and an untoothed portion. The carriage is slidably engaged with the rack. The gear assembly is disposed in the carriage and slidably engaged with the rack. The spring extends along the untoothed portion to urge the gear assembly toward the gear teeth set.

In yet another aspect, a pivoting assembly is disclosed, which includes a jamb, a door, and a linear damper. The door is pivotably engaged with the jamb. The linear damper is connected to the jamb and the door. The linear damper includes a rack, a carriage, a gear assembly, and a spring. The rack includes an end. The carriage is slidably engaged with the rack. The gear assembly is between the carriage and the rack. The spring is secured to the rack to urge the carriage away from the first end.

### BRIEF DESCRIPTION OF THE DRAWINGS

FIG. 1 is an isometric view of a damper assembly, according to a first exemplary embodiment;

FIG. 2 is another isometric view of the damper assembly of FIG. 1;

FIG. 3A is a top view of the damper assembly of FIGS. 1 and 2;

FIG. 3B is a bottom view of the damper assembly of FIGS. 1-3A;

FIG. 4A is a front view of the damper assembly of FIGS. 1-3B;

FIG. 4B is a back view of the damper assembly of FIGS. 1-4A;

FIG. 5A is a left view of the damper assembly of FIGS. 1-4B;

FIG. 5B is a right view of the damper assembly of FIGS. 1-5A;

FIG. 6 is an exploded isometric view of the damper assembly of FIGS. 1-5B;

FIG. 7 is another exploded isometric view of the damper assembly of FIGS. 1-6;

FIG. 8A is an exploded top view of the damper assembly of FIGS. 1-7;

FIG. 8B is an exploded bottom view of the damper assembly of FIGS. 1-8A;

FIG. 9A is an exploded front view of the damper assembly of FIGS. 1-8B;

FIG. 9B is an exploded back view of the damper assembly of FIGS. 1-9A;

FIG. 10A is an exploded left view of the damper assembly of FIGS. 1-9B;

FIG. 10B is an exploded right view of the damper assembly of FIGS. 1-10A;

FIG. 11 is an isometric view of a rack of the damper assembly of FIGS. 1-10B;

FIG. 12 is another isometric view of the rack of FIG. 11;

FIG. 13A is a top view of the rack of FIGS. 11 and 12;

FIG. 13B is a bottom view of the rack of FIGS. 11-13A;

FIG. 14A is a front view of the rack of FIGS. 11-13B;

FIG. 14B is a back view of the rack of FIGS. 11-14A;

FIG. 15A is a left view of the rack of FIGS. 11-14B;

FIG. 15B is a right view of the rack of FIGS. 11-15A;

FIG. 16 is an isometric view of a carriage of the damper assembly of FIGS. 1-10B;

FIG. 17 is a cross-sectional isometric view of the carriage of FIG. 16 taken along line 17-17 of FIG. 16;

FIG. 18 is another isometric view of the carriage of FIGS. 16 and 17;

FIG. 19A is a top view of the carriage of FIGS. 16-18;

FIG. 19B is a bottom view of the carriage of FIGS. 16-19A;

FIG. 20A is a front view of the carriage of FIGS. 16-19B;

FIG. 20B is a back view of the carriage of FIGS. 16-20A;

FIG. 21A is a left view of the carriage of FIGS. 16-20B;

FIG. 21B is a right view of the carriage of FIGS. 16-21A;

FIG. 22 is an isometric view of a switch of the damper assembly of FIGS. 1-10B;

FIG. 23 is another isometric view of the switch of FIG. 22;

FIG. 24 is a cross-sectional isometric view of the switch of FIGS. 22 and 23 taken along line 24-24 of FIG. 22;

FIG. 25 is an isometric view of a gear assembly of the damper assembly of FIGS. 1-10B;

FIG. 26 is a cross-sectional isometric view of the gear assembly of FIG. 25 taken along line 26-26 of FIG. 25;

FIG. 27 is an isometric view of a pinion of the gear assembly of FIGS. 25 and 26;

FIG. 28 is another isometric view of the pinion of FIG. 27;

FIG. 29 is an isometric view of a cap of the gear assembly of FIGS. 25 and 26;

FIG. 30 is a cross-sectional isometric view of the cap of FIG. 29 taken along line 30-30 of FIG. 29;

FIG. 31 is an isometric view of a rotor of the gear assembly of FIGS. 25 and 26;

FIG. 32 is a cross-sectional isometric view of the rotor of FIG. 31 taken along line 32-32 of FIG. 31;

FIG. 33A is a front view of the rotor of FIGS. 31 and 32;

FIG. 33B is a back view of the rotor of FIGS. 31-33A;

FIG. 34 is an isometric view of a housing of the gear assembly of FIGS. 25 and 26;

FIG. 35 is a cross-sectional isometric view of the housing of FIG. 34 taken along line 35-35 of FIG. 34;

FIG. 36A is a front view of the housing of FIGS. 34 and 35;

FIG. 36B is a back view of the housing of FIGS. 34-36A; and

FIG. 37 is a schematic view of the damper assembly of FIGS. 1-10B installed in a pivoting assembly.

### DETAILED DESCRIPTION

As explained herein, the present disclosure provides a linear damper that provides assistance to initially start and subsequently control movement of pivoting components relative to one another. Additionally, the linear damper may hold pivoting components in a closed position relative to one another. As non-limiting examples, the linear damper may be configured to engage with center console hatches, glovebox assemblies, storage compartment lids, etc.

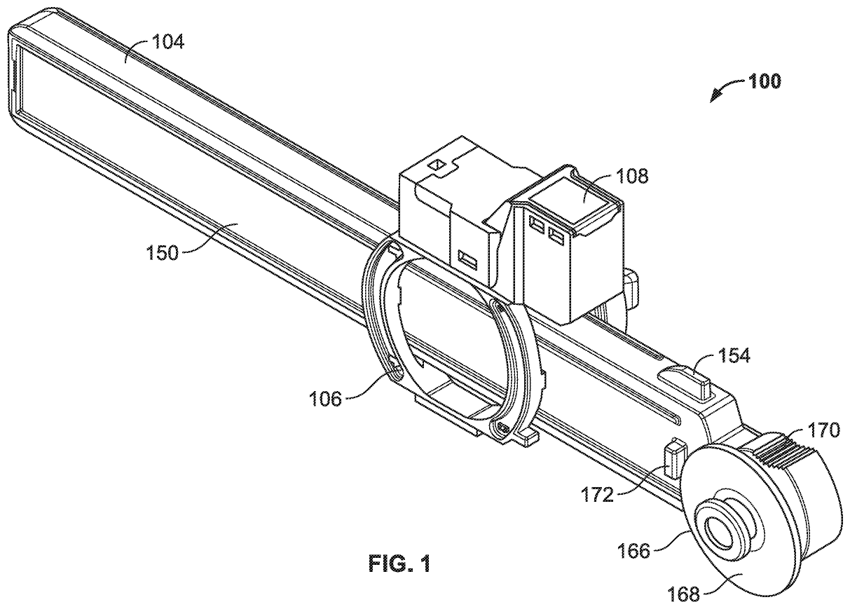

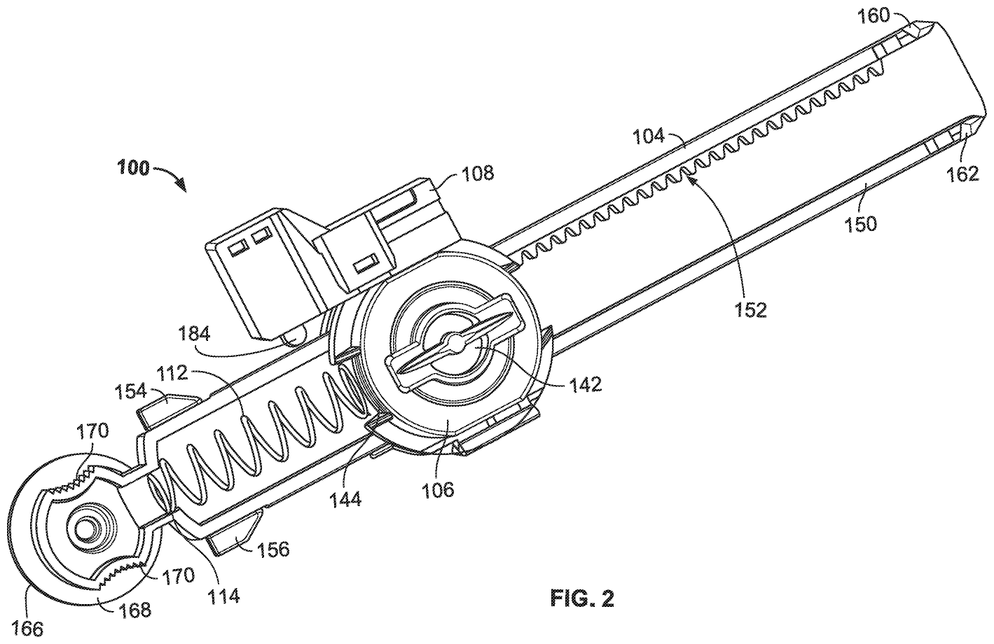

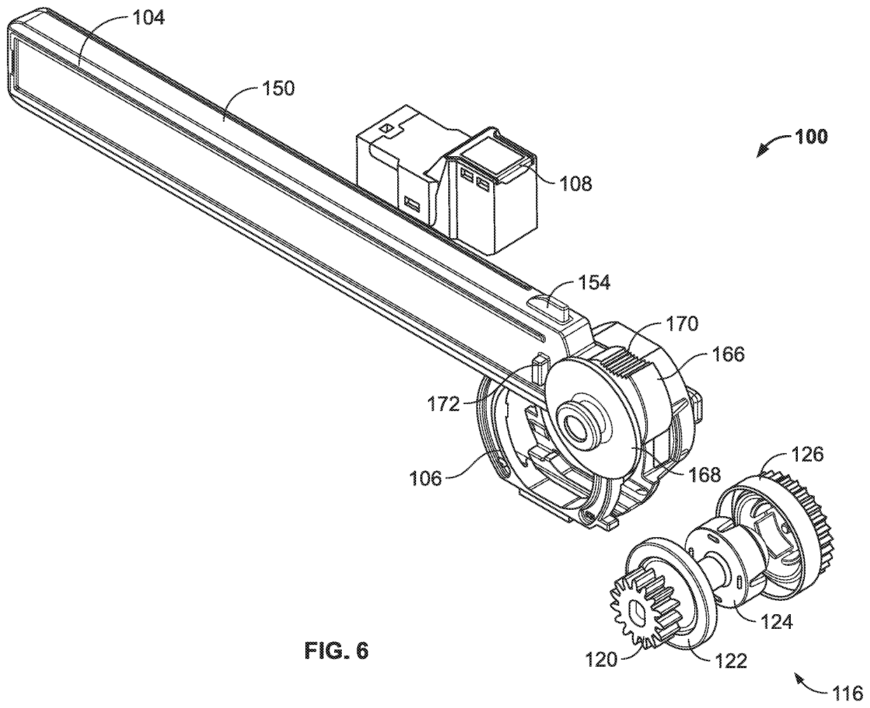

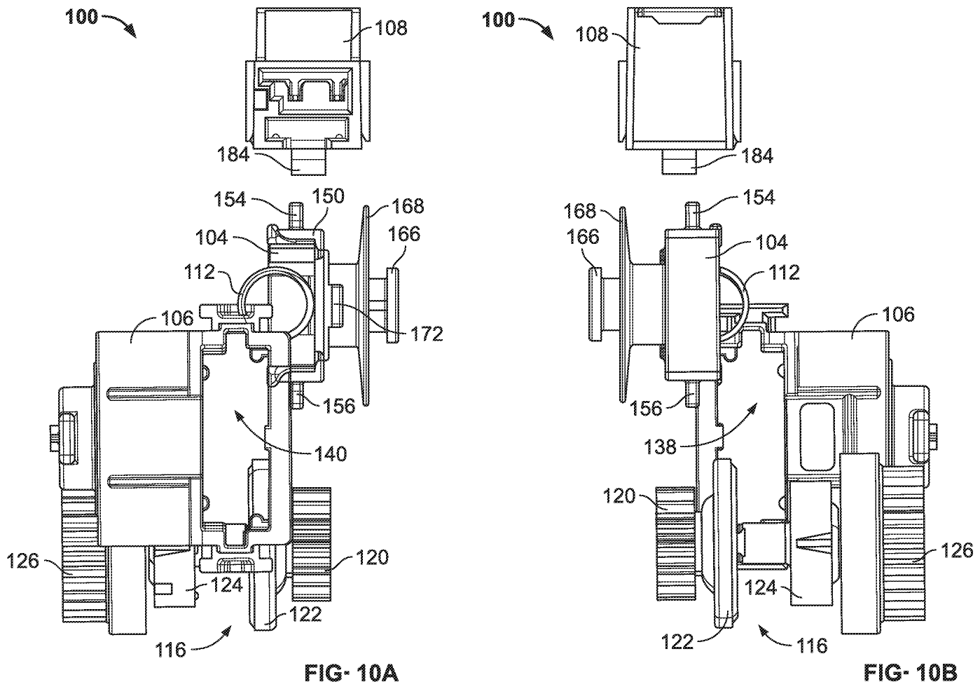

With reference to FIGS. 1-10B, a linear damper 100 includes a rack 104, a carriage 106, and a switch 108. The carriage 106 is slidably engaged with the rack 104. The switch 108 is mounted on the carriage 106. With reference to FIGS. 2, 3A, 3B, 4B, 5B, 7, 8A, 9, 10A, and 10B, the linear damper 100 includes a spring 112. With reference to FIG. 2, the rack 104 includes an end 114. The spring 112 is secured to the rack 104 at the end 114 to selectively contact the carriage 106. The spring 112 extends partially along the rack 104.

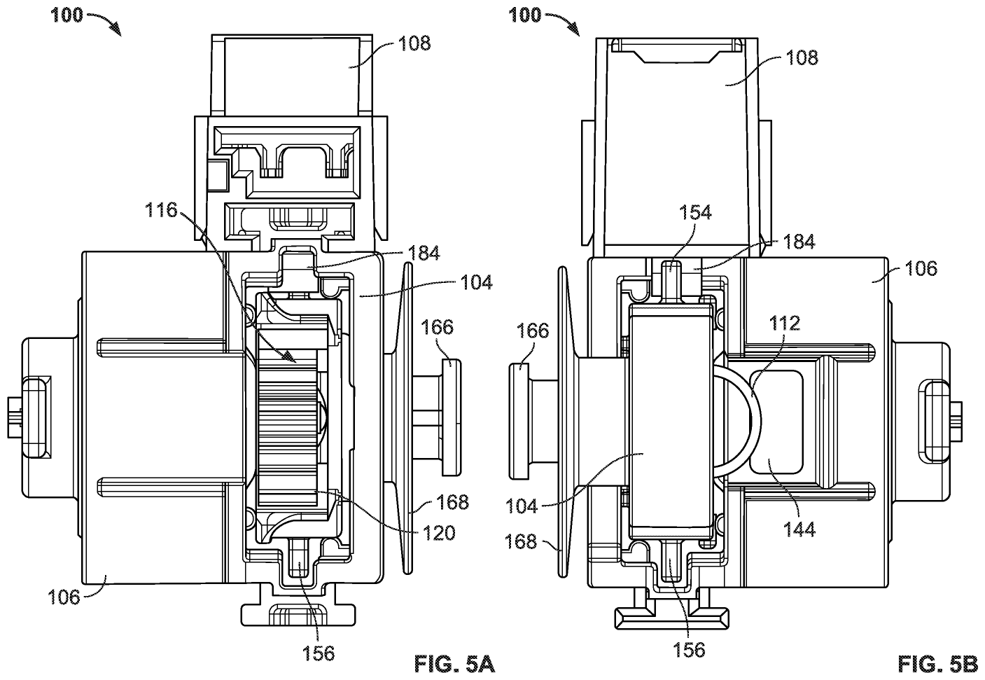

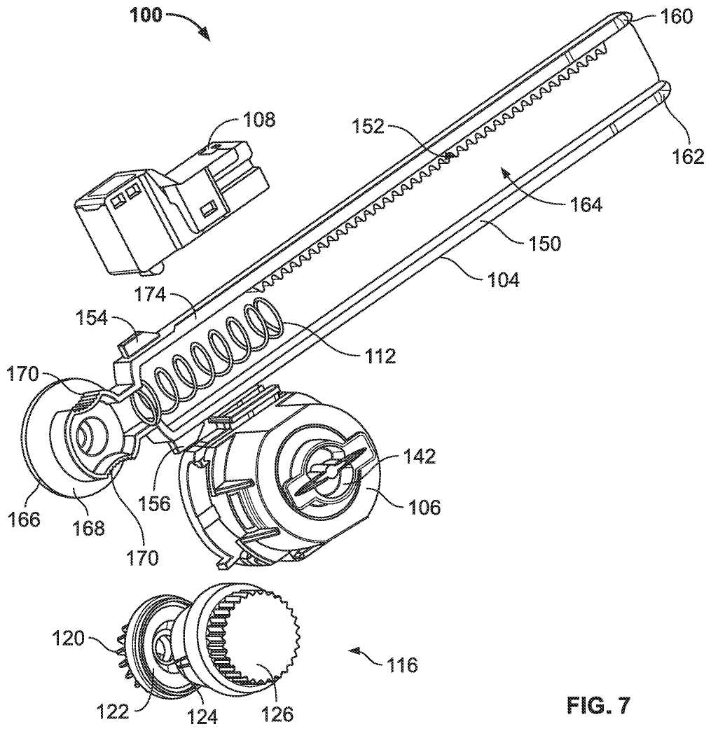

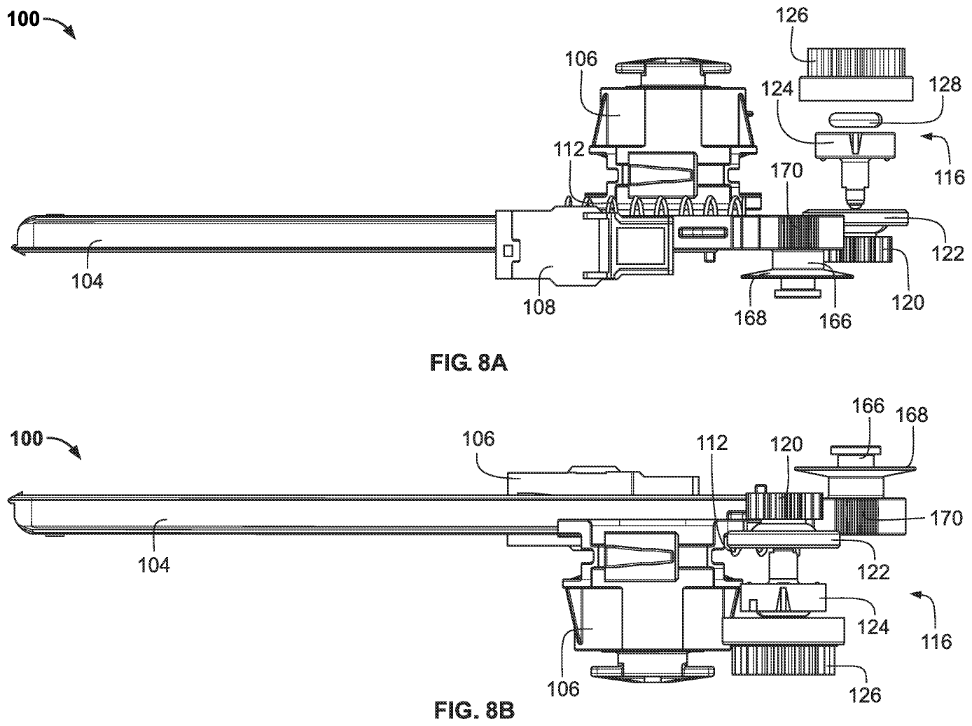

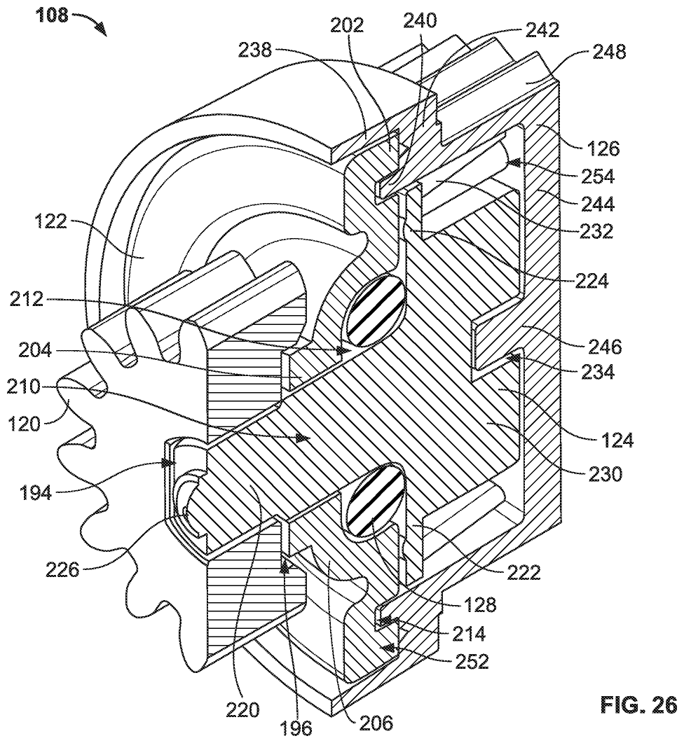

With reference to FIGS. 5A and 6-10B, the linear damper 100 includes a gear assembly 116. The gear assembly 116 is captured between the carriage 106 and the rack 104. The gear assembly 116 is rotatably engaged with the carriage 106. The gear assembly 116 is drivably engaged with the rack 104. Looking at FIGS. 8A and 26, the gear assembly 116 includes a pinion 120, a cap 122, a rotor 124, a housing 126, and an O-ring 128. The gear assembly 116 also includes damping grease (not shown). With reference to FIG. 26, the pinion 120 is engaged with the rotor 124. The cap 122 is engaged with the housing 126. The rotor 124 is partially disposed in the housing 126 and extends through the cap 122. The rotor 124 is rotatably engaged with the housing 126 and the cap 122. The O-ring 128 is captured between the rotor 124 and the cap 122. The O-ring 128 is rotatably engaged with the rotor 124. The pinion 120 and the rotor 124 rotate together as a unit relative to the cap 122, the housing 126, and the O-ring 128. With reference to FIG. 7, in operation, the rack 104 drives the pinion 120 to turn the rotor 124 relative to the housing 126 through the damping grease. Thus, when the rotor 124 rotates relative to the housing 126, sliding movement of the carriage 106 relative to the rack 104 is damped.

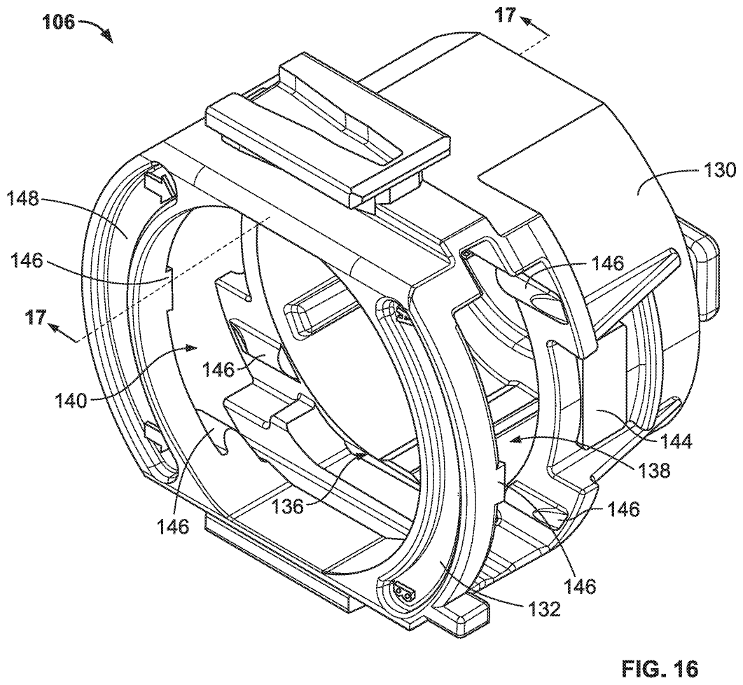

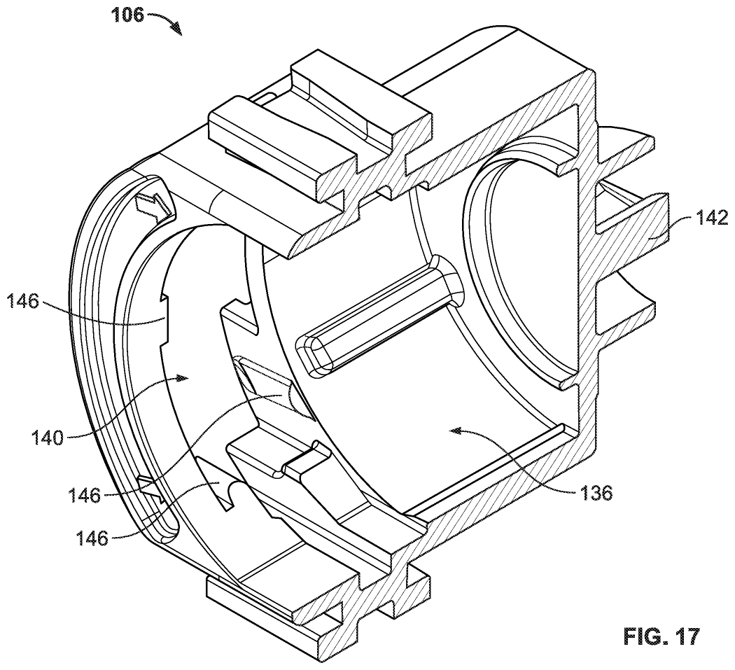

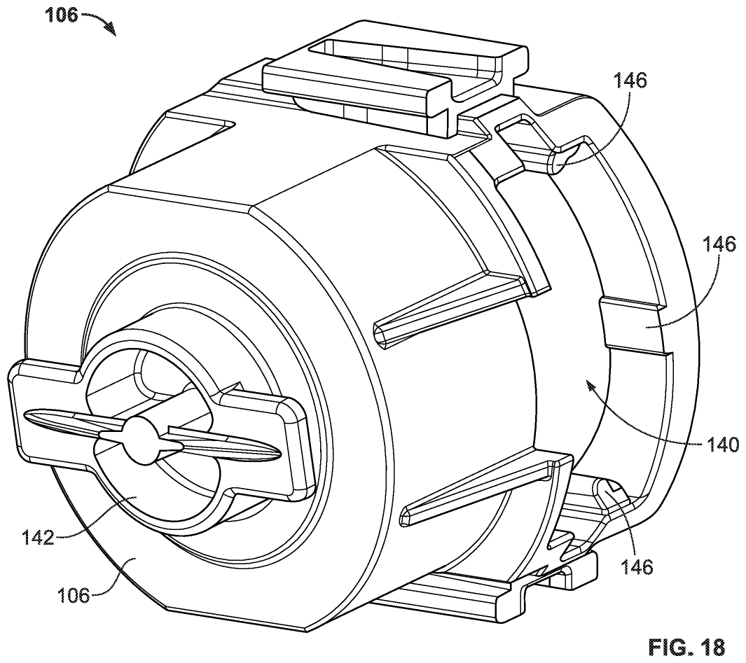

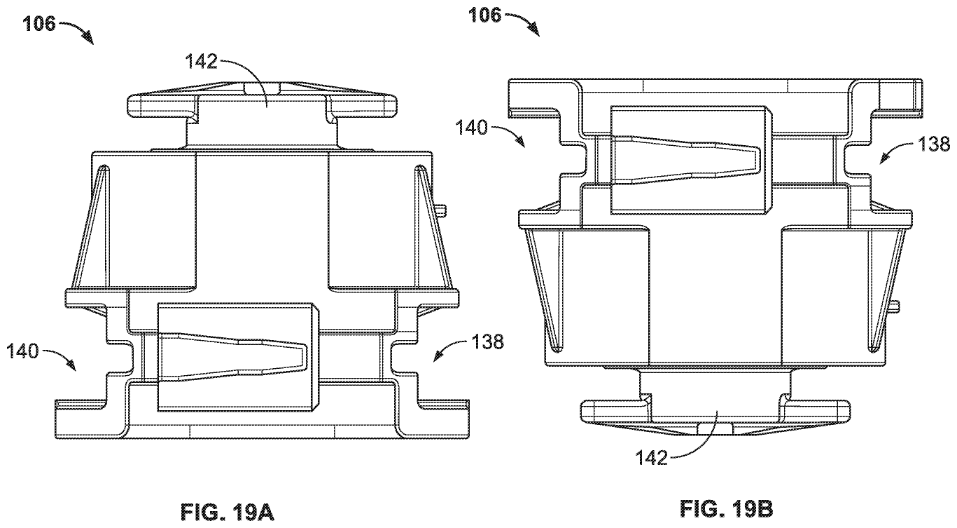

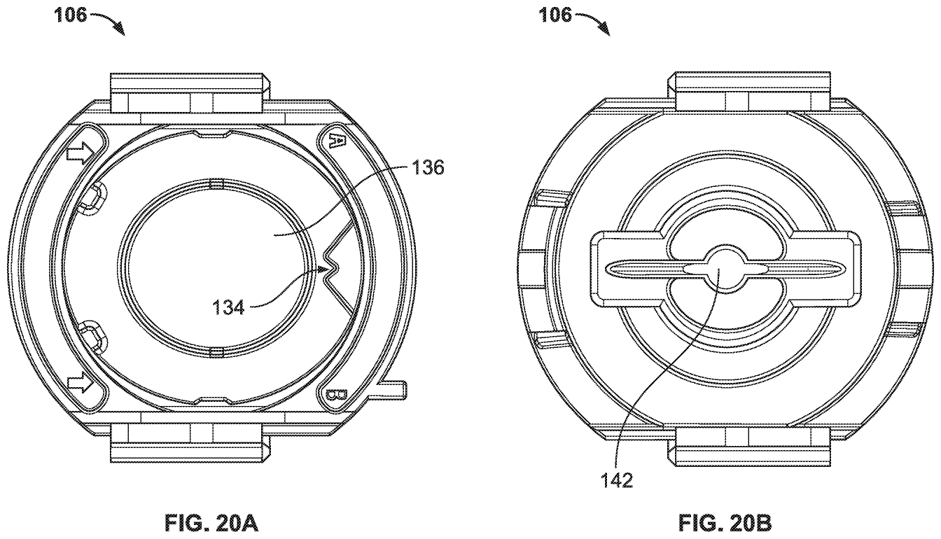

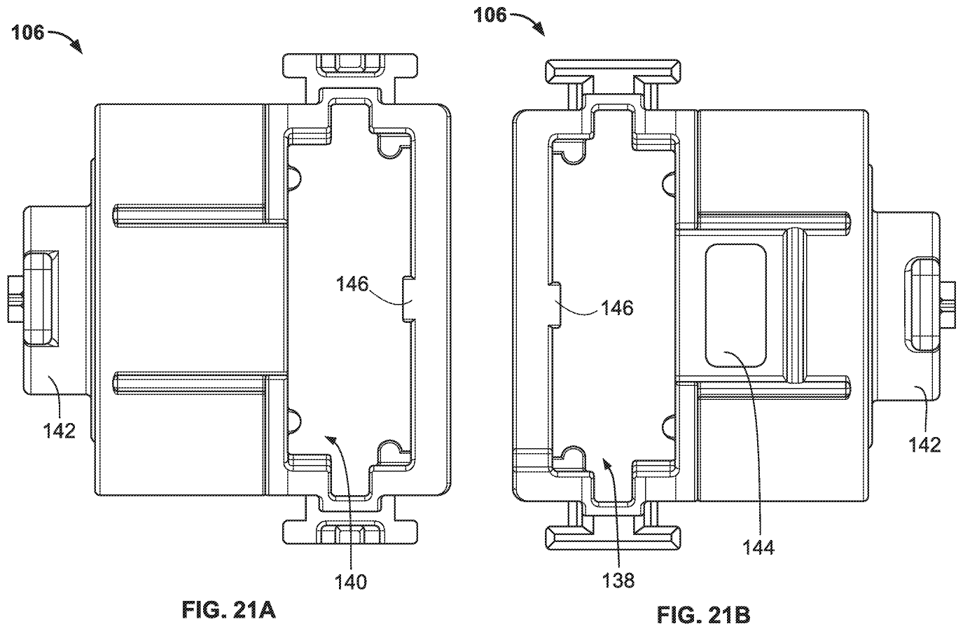

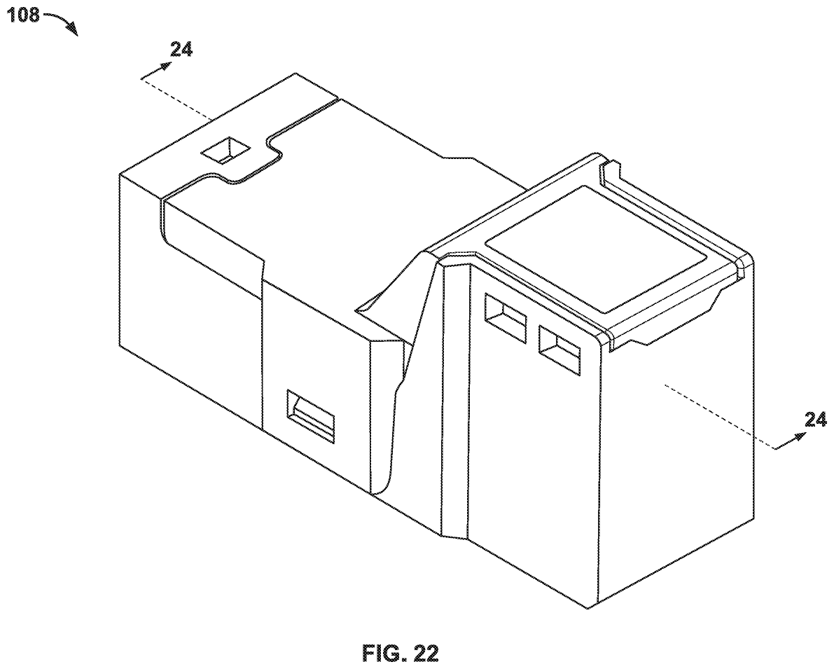

With reference to FIG. 20A, the carriage 106 includes a housing 130 and a first bridge 132. The carriage 106 defines an internal notch 134. With reference to FIG. 16, the carriage defines a cavity 136, a first slot 138, and a second slot 140. With reference to FIGS. 17-19B, 20B, 21A, and 21B, the carriage 106 includes a first connector 142. With reference to FIGS. 16 and 21B, the carriage 106 includes a spring pad 144. With reference to FIGS. 16-18, 21A, and 21B, the carriage 106 includes a plurality of sliding pads 146. With reference to FIG. 16, the carriage 106 further includes a second bridge 148. The first bridge 132 and the second bridge 148 are connected to the housing 130. More specifically, the first bridge 132 the second bridge 148, and the housing 130 define the cavity 136. The first bridge 132 and the housing 130 define the first slot 138. The second bridge 148 and the housing 130 define the second slot 140. The spring pad 144 is connected to and extends outwardly from the housing 130. The plurality of sliding pads 146 extend from the first bridge 132, the second bridge 148, and the housing 130 into the first slot 138 and the second slot 140. In some embodiments, the carriage 106 is integrally formed as a unitary component.

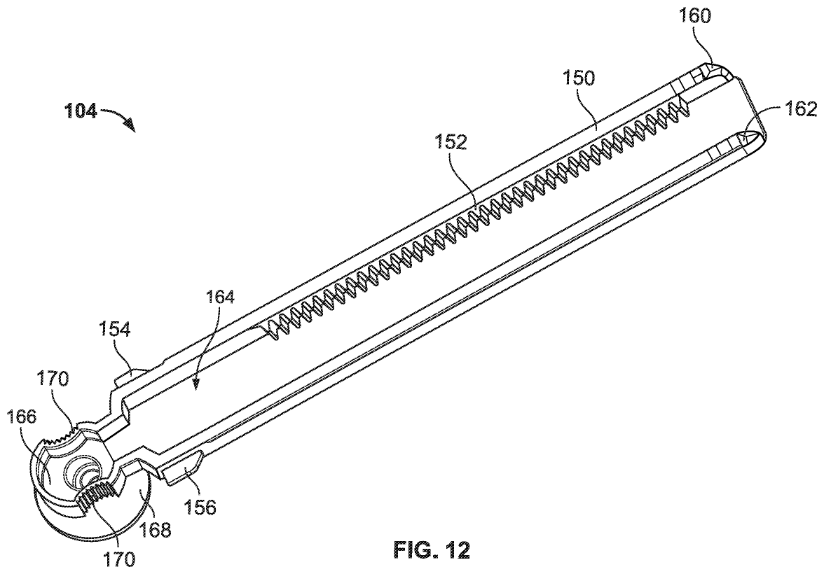

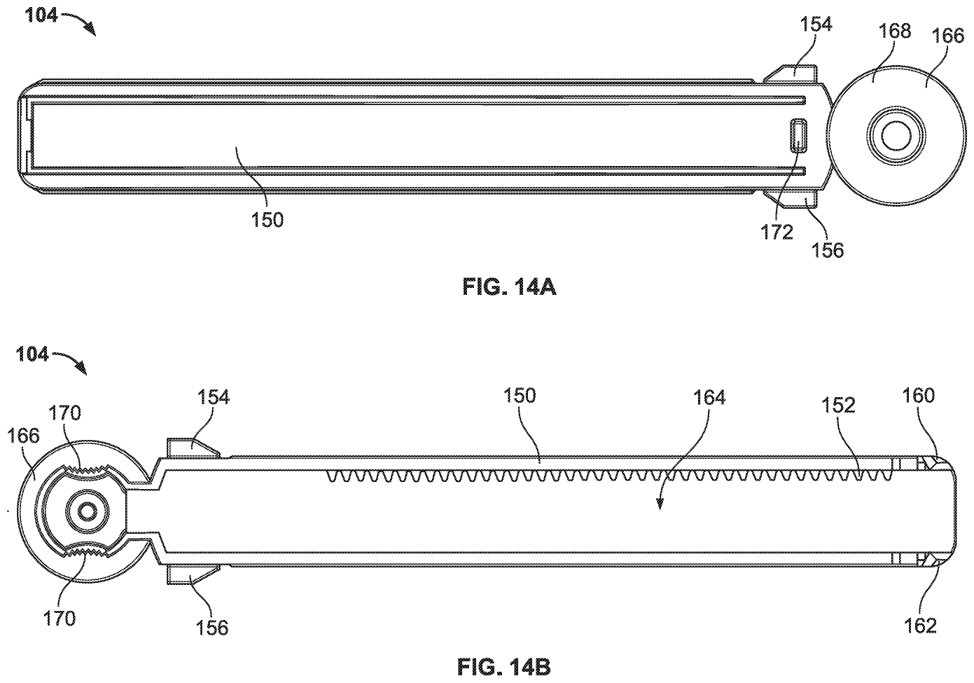

With reference to FIGS. 12 and 14B, the rack 104 includes an elongated body 150, a gear teeth set 152, a first switch tab 154, a second switch tab 156, a first snap tooth 160, and a second snap tooth 162. The elongated body 150 defines a channel 164. The gear teeth set 152 is connected to and extends along a portion of the elongated body 150 into the channel 164. The first switch tab 154 is connected to and extends outwardly from the elongated body 150. The second switch tab 156 is connected to and extends from the elongated body 150. The second switch tab 156 is opposite the first switch tab 154. The first snap tooth 160 and second snap tooth 162 are connected to and extend from the elongated body 150. The first snap tooth 160 and the second snap tooth 162 are generally parallel with one another.

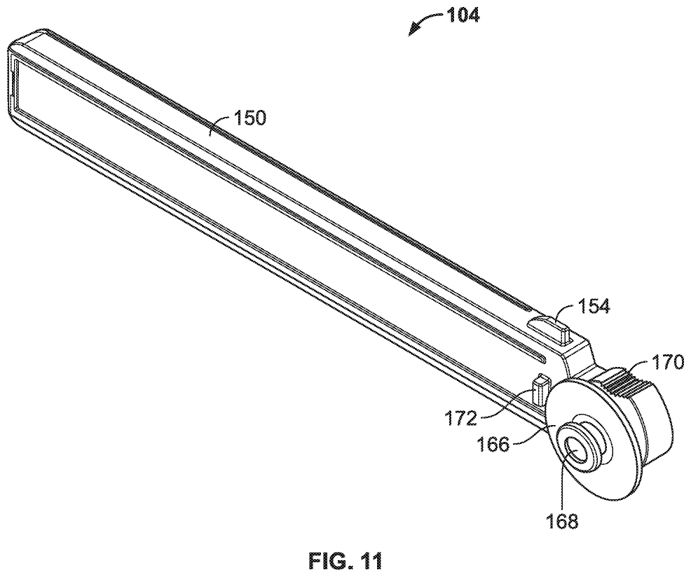

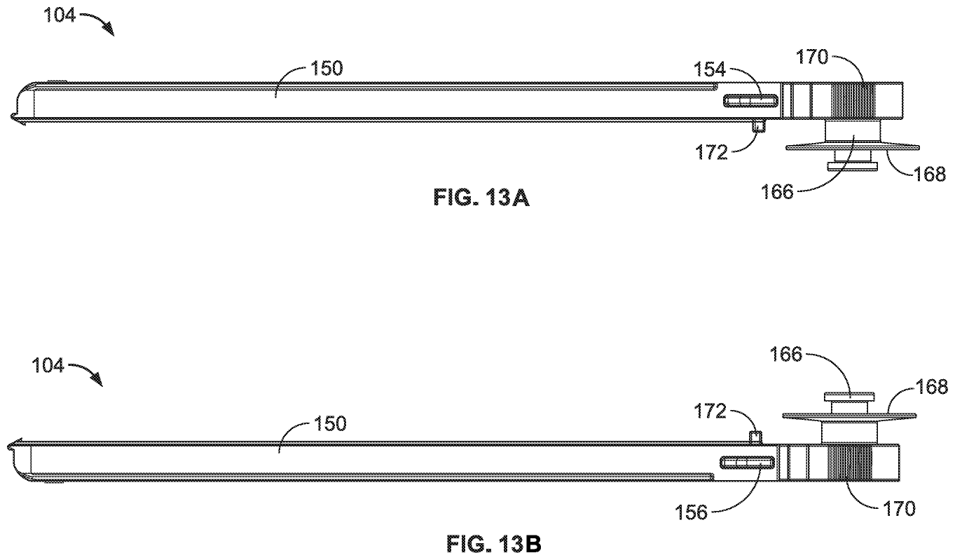

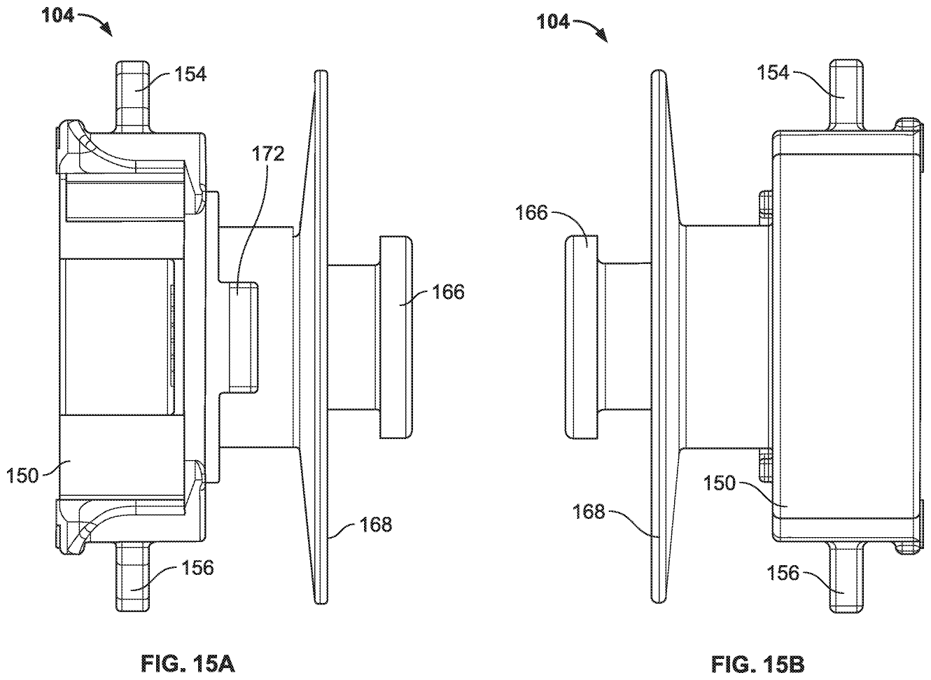

With reference to FIGS. 11, 13A, 13B, 14A, 15A, and 15B, the rack 104 includes a second connector 166. The second connector 166 includes a washer portion 168. With reference to FIG. 14B, the second connector includes finger grooves 170. The second connector 166 is connected to and extends from the elongated body 150. The washer portion 168 is aligned with the elongated body 150. With reference to FIGS. 13A-14A and 15A, the rack 104 includes a stop tab 172. The stop tab 172 is connected to and extends from the elongated body 150. With reference to FIG. 14A, the stop tab 172 is generally perpendicular to the first switch tab 154 and the second switch tab 156.

With reference to FIG. 7, the gear teeth set 152 is configured to drivably mesh with the pinion 120. The first snap tooth 160 and second snap tooth 162 are opposite the spring 112. The spring 112 extends along an untoothed portion 174 of the elongated body 150.

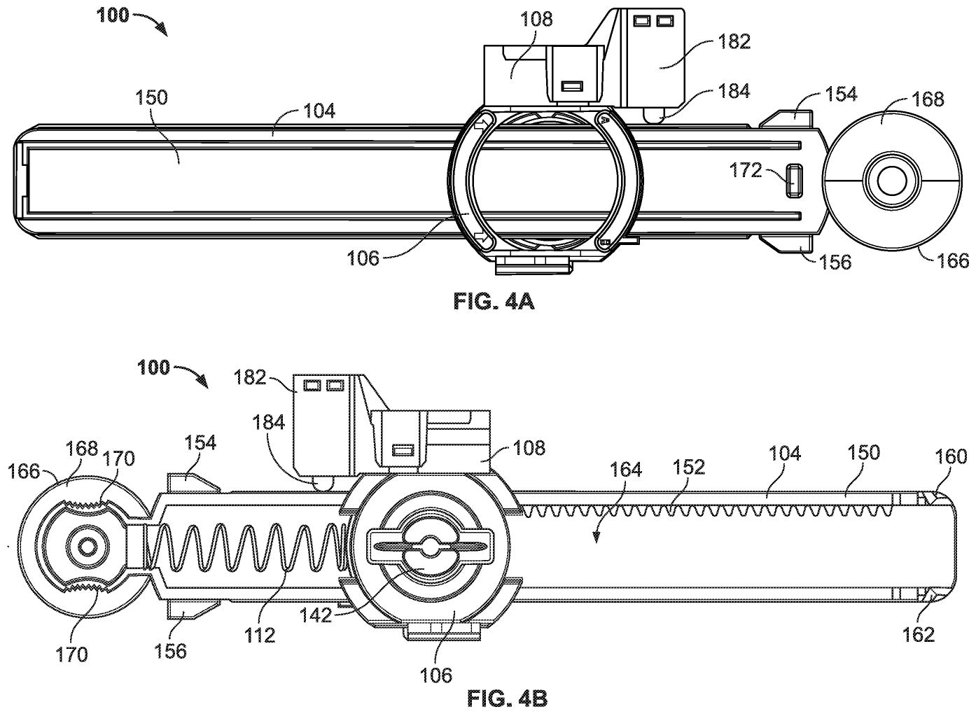

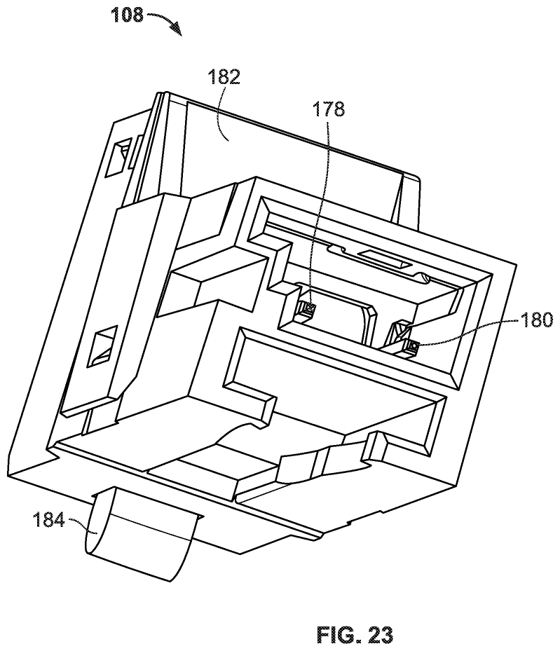

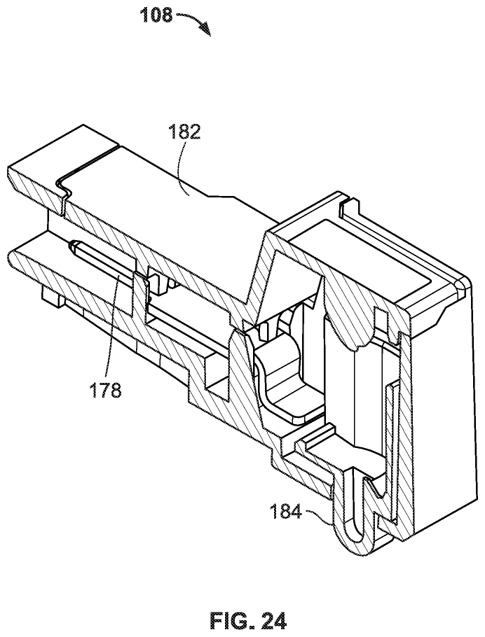

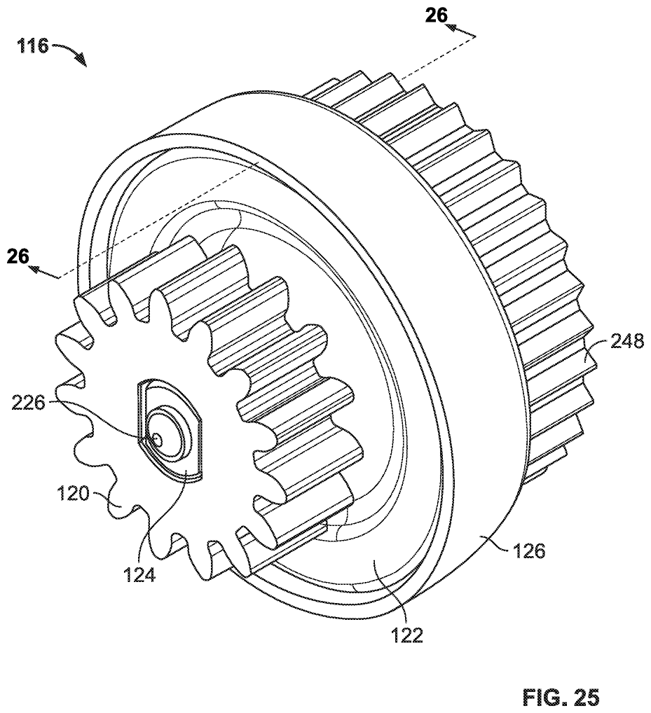

With reference to FIG. 23, the switch 108 includes a first electrode 178 and a second electrode 180. With reference to FIG. 24, the switch 108 includes a housing 182 and a lift connector 184. The lift connector 184 is pivotably engaged with the housing 182. With reference to FIG. 23, the lift connector 184 pivots into the housing 182 to selectively place the first electrode 178 into electrical communication with the second electrode 180. With reference to FIG. 4B, in operation, when the lift connector 184 selectively contacts and slides over the first switch tab 154, the lift connector 184 pivots into the housing 182. It should be understood that the switch 108 may be alternatively mounted on the carriage 106 for the lift connector 184 to selectively contact and slide over the second switch tab 156 (not shown).

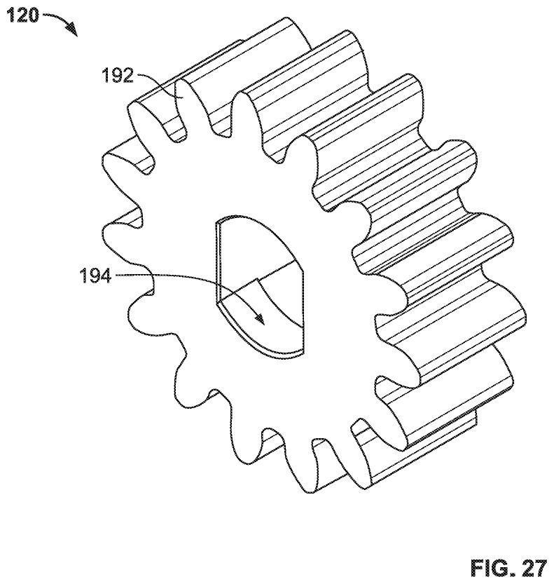

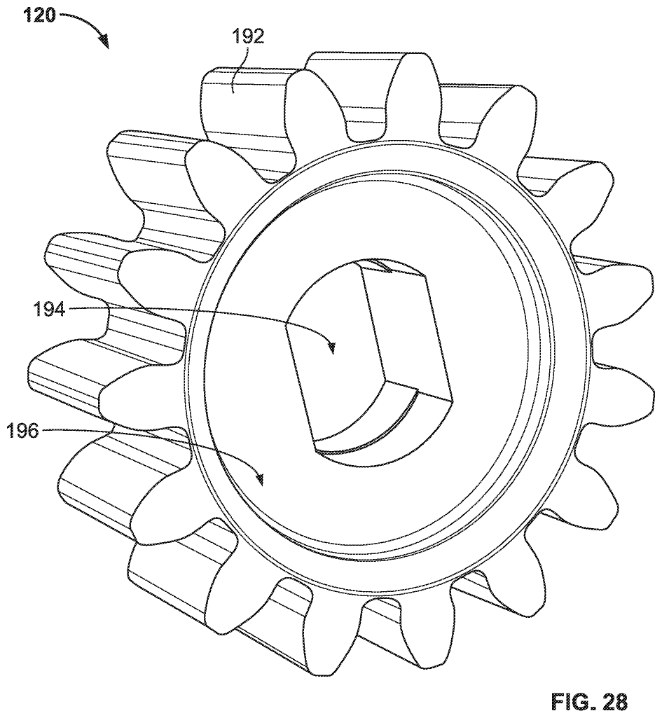

With reference to FIGS. 27 and 28, the pinion 120 includes a second gear teeth set 192. With reference to FIG. 28, the pinion 120 defines an opening 194 and a cavity 196.

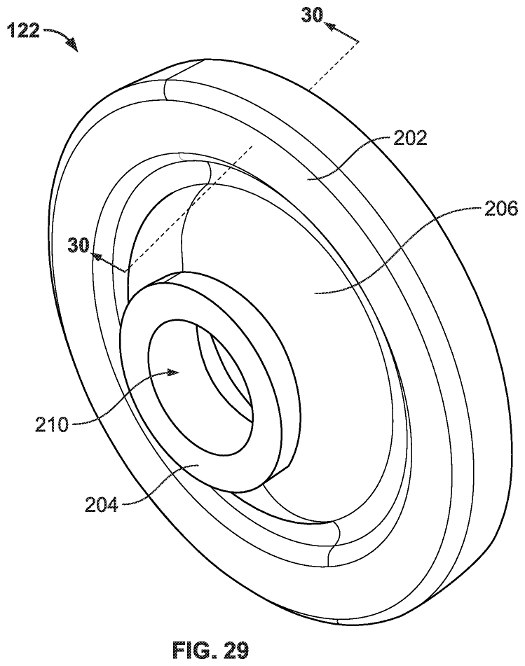

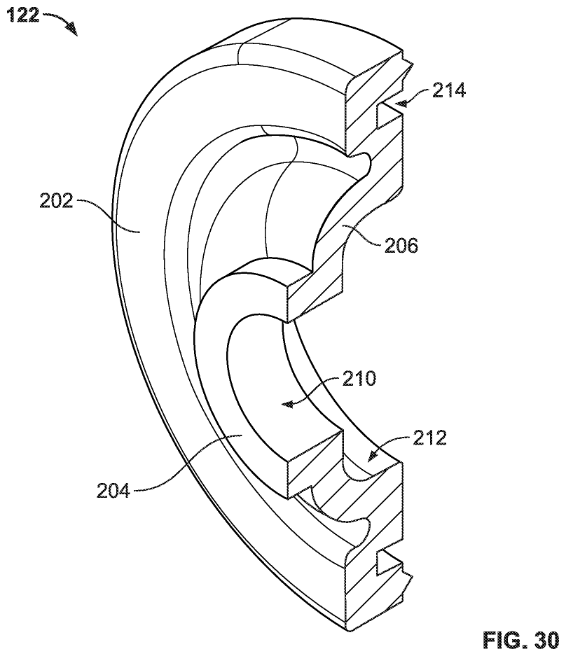

With reference to FIGS. 29 and 30, the cap 122 includes an outer ring 202, an inner ring 204, and a bell portion 206. The bell portion 206 is connected to and between the inner ring 204 and the outer ring 202. The inner ring 204 defines an opening 210. With reference to FIG. 30, the bell portion 206 defines a cavity 212. The outer ring 202 defines an annular groove 214. The inner ring 204 is disposed in the cavity 196. The bell portion 206 is partially disposed in the cavity 196. The O-ring 128 is disposed in the cavity 212.

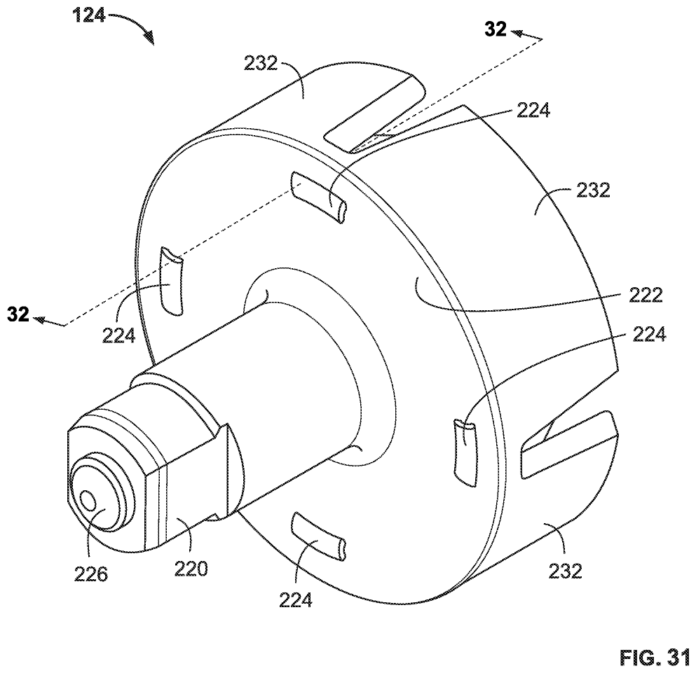

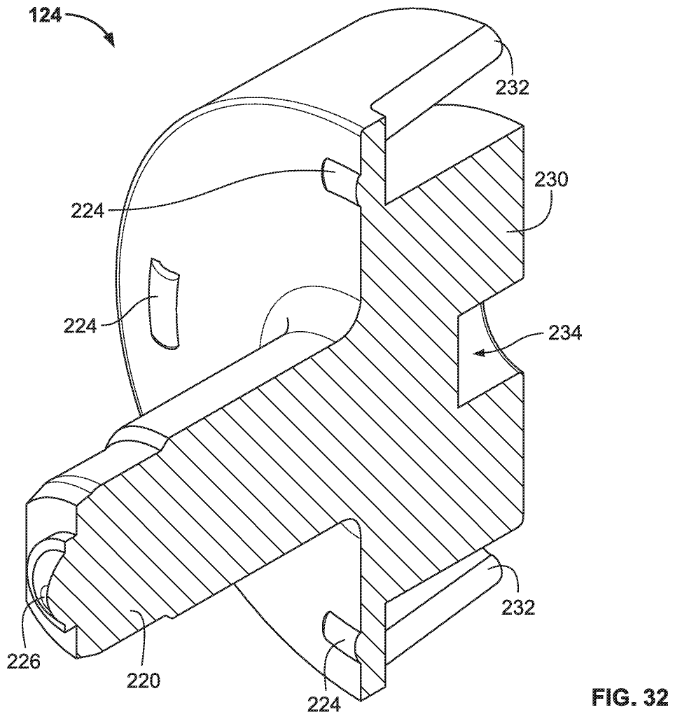

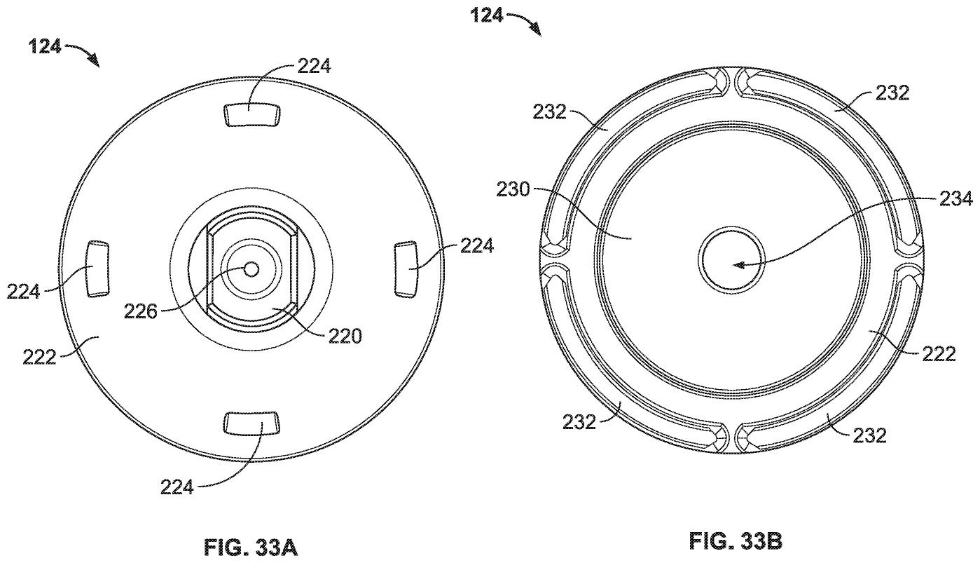

With reference to FIGS. 31-33A, the rotor 124 includes a post 220, a disk portion 222, and a plurality of sliding pads 224. The post 220 includes a contact pad 226. The post 220 and the plurality of sliding pads 224 extend from the disk portion 222. With reference to FIGS. 32 and 33B, the rotor 124 includes an inner portion 230 and a first shear fin set 232. The inner portion 230 and the first shear fin set 232 extend from the disk portion 222 opposite the post 220 and the plurality of sliding pads 224. The inner portion 230 defines a cavity 234. With reference to FIG. 26, the post 220 is inserted through the cavity 196 and into to the opening 194 to connect to the pinion 120. The post 220 extends through the cap 122 via the opening 210. The plurality of sliding pads 224 are slidably engaged with the bell portion 206.

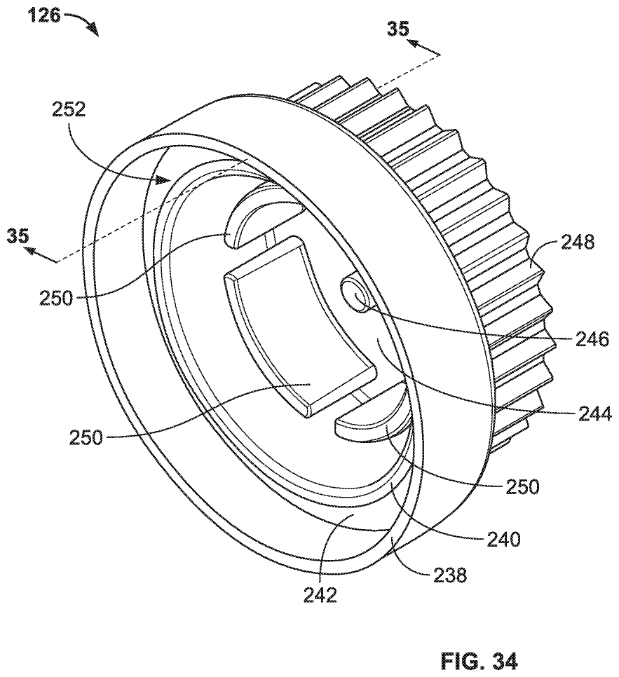

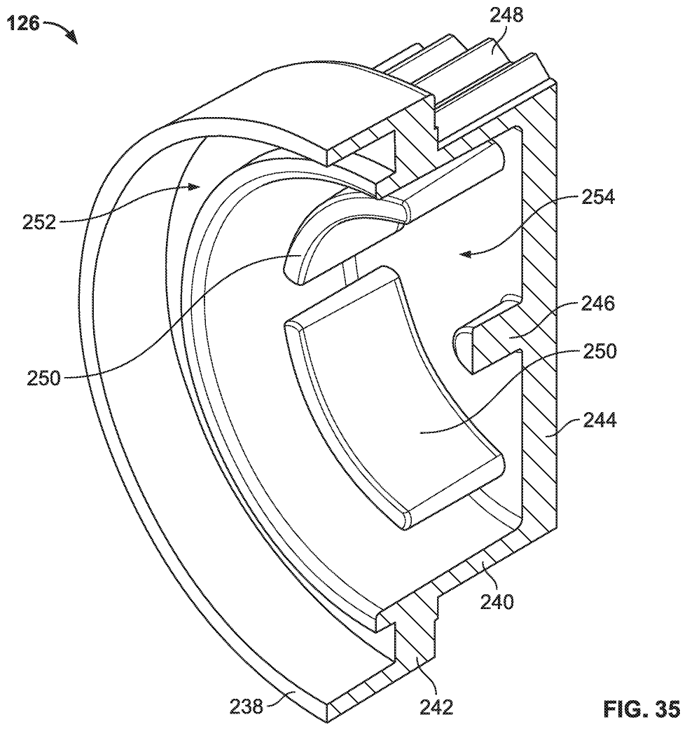

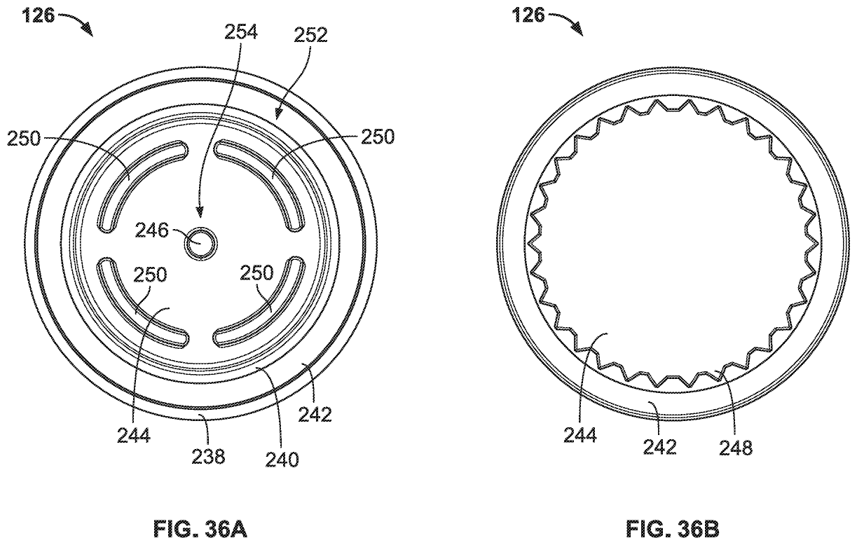

With reference to FIGS. 34-36A, the housing 126 includes an outer ring 238, an inner ring 240, a flange portion 242, a disk portion 244, a post 246, a pawl teeth set 248, and a second shear fin set 250. The inner ring 240, the flange portion 242, and the disk portion 244 define a channel 252. The inner ring 240 and the disk portion 244 define a well 254. The flange portion 242 is connected to and between the outer ring 238 and the inner ring 240. The disk portion 244 is connected to the inner ring 240. The post 246 and the second shear fin set 250 are connected to and extend from the disk portion 244. The post 246 and the second shear fin set 250 are disposed in the well 254. The pawl teeth set 248 extends radially outwardly from the inner ring 240.

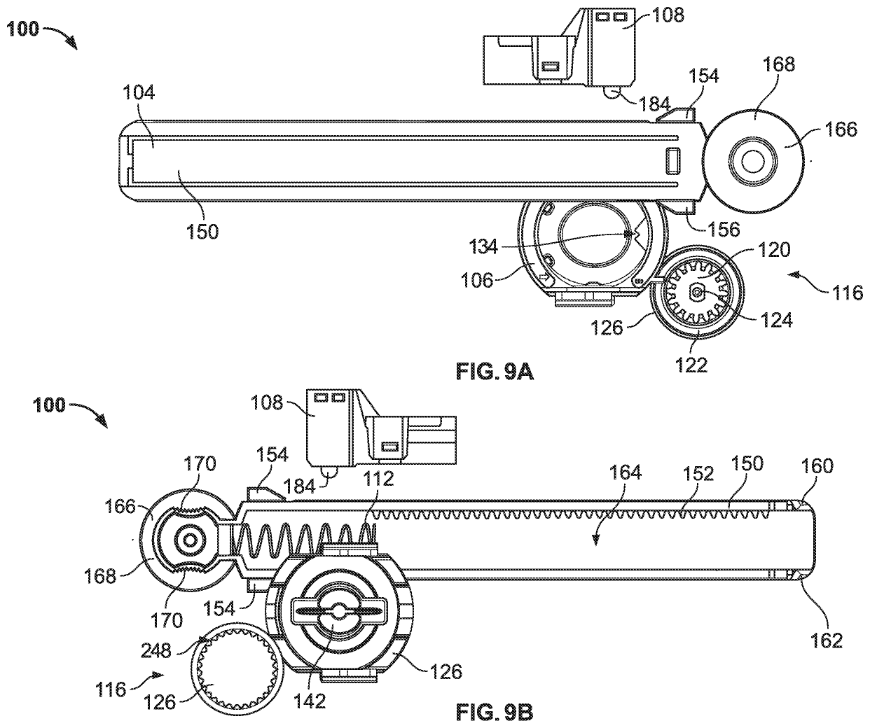

With reference to FIG. 9B, the gear assembly 116 ratchetingly engages the carriage 106 via the pawl teeth set 248 and the internal notch 134 (shown in FIG. 9A). More specifically, in operation, the pawl teeth set 248 engages the internal notch 134 when the carriage 106 moves away from the second connector 166. Thus, the gear assembly 116 damps movement of the carriage 106 away from the second connector 166 along the rack 104. Further in operation, the pawl teeth set 248 disengages from the internal notch 134 and the gear assembly 116 rotates freely within the carriage 106 when the carriage moves toward the second connector 166. Thus, movement of the carriage 106 toward the second connector 166 along the rack 104 is undamped. In other words, when the carriage 106 moves toward the second connector 166, the carriage 106 slides freely along the rack 104.

With reference to FIG. 26, the outer ring 202 is inserted into the channel 252. The inner ring 240 is inserted into the annular groove 214. The inner portion 230 and the first shear fin set 232 are disposed in the well 254. The post 246 is rotatably engaged with the inner portion 230 via the cavity 234. The flange portion 242 is engaged with the outer ring 202.

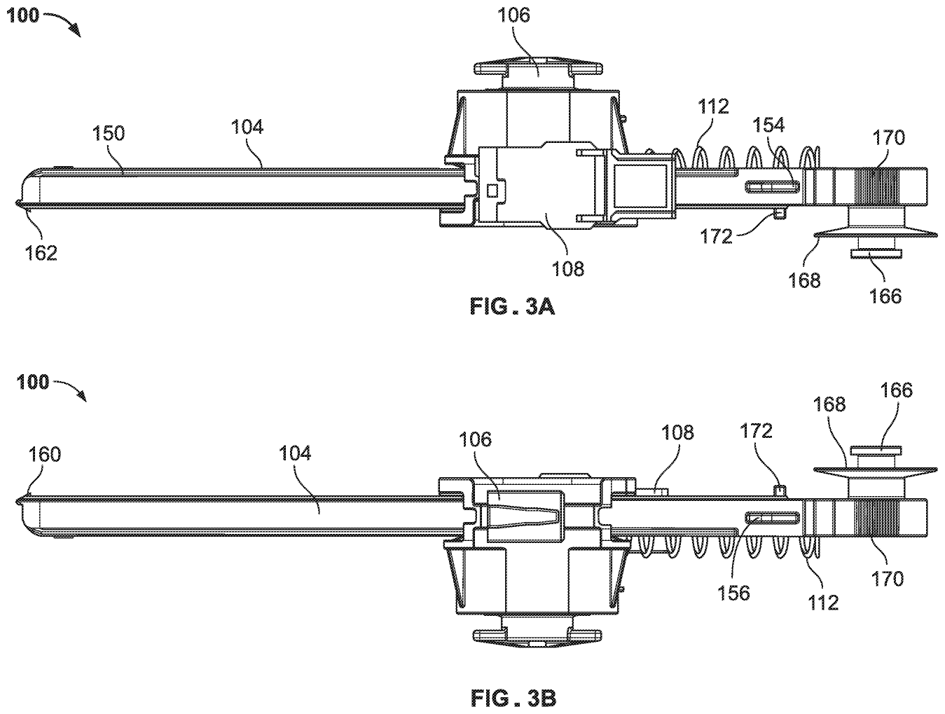

With reference to FIGS. 2, 3A, 3B, and 4B, the spring 112 is secured in the rack 104 in the channel 164. The carriage 106 is slidably engaged with the rack 104. The switch 108 is engaged with the carriage 106. Looking specifically at FIG. 2, the spring 112 selectively contacts the spring pad 144 to urge the carriage away from the second connector 166. With reference to FIG. 3A, in operation, the stop tab 172 and the second snap tooth 162 provide opposing hard stops to limit sliding motion of the carriage 106 along the elongated body 150. With reference to FIG. 3B, in operation, the first snap tooth 160 also provides a hard stop opposite the stop tab 172 to limit sliding motion of the carriage 106 along the elongated body 150. When the carriage 106 contacts the stop tab, the spring is compressed.

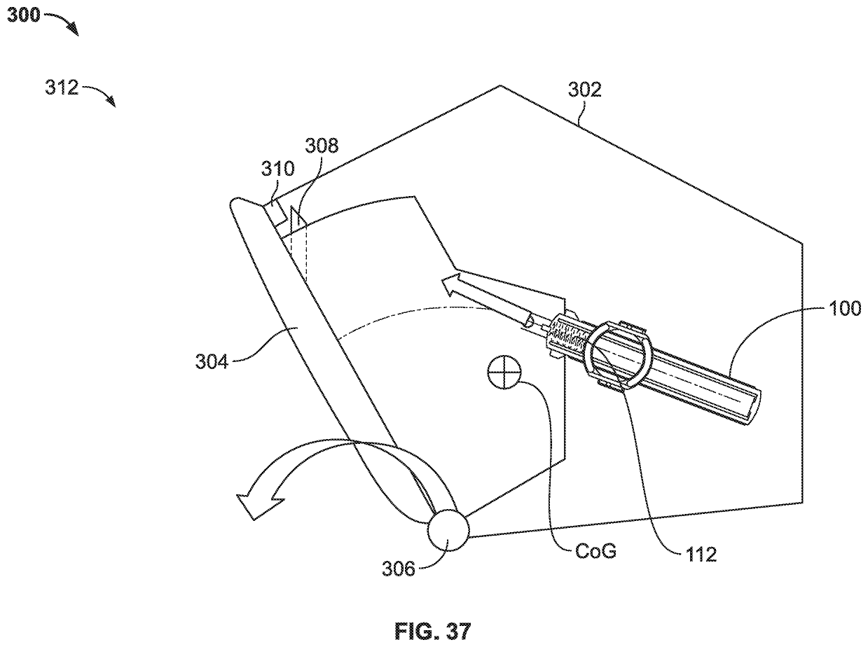

With reference to FIG. 37, the linear damper 100 is installed in a pivoting assembly 300. The pivoting assembly 300 also includes a jamb 302, a door 304, and a hinge 306. The door 304 includes a latch 308 (shown partially in phantom) and has a center of gravity CoG. The jamb 302 has a catch 310. In the example of FIG. 37, the door 304 is secured via the latch 308 and the catch 310 in a closed position 312. In the closed position 312 the center of gravity CoG of the door 304 is closer to the jamb 302 than the hinge 306. Thus, the door 304 is urged toward the closed position 312 by gravity. In the closed position 312, the door 304 the spring 112 (shown in phantom) is compressed between the rack 104 and the carriage 106. When the latch 308 is released from the catch 310, the spring 112 pushes the door 304 about the hinge 306 until the center of gravity CoG passes the hinge 306. In other words, the spring 112 gives an initial thrust to move the center of gravity CoG past vertical when the door 304 is released. Once the center of gravity CoG is further from the jamb 302 than the hinge 306, gravity pulls the door 304 downwardly. The linear damper 100 controls and slows the descent of the door 304 away from the jamb 302.

From the foregoing, it will be appreciated that the above-disclosed linear damper 100 provides assistance to open pivoting assemblies quickly, easily, and repeatably while minimizing forces to close the pivoting assembly. For example, the above-disclosed linear damper 100 anticipates a driver's frustration of having to tug on a glovebox door to open the glovebox. Thus, the linear damper 100 obviates the need to equip pivoting assemblies (e.g., gloveboxes, storage hatches, center consoles, etc.) with electric motors and/or powered actuators. Thus, the linear damper 100 conserves resources and may provide a vehicle better fuel economy as compared to a vehicle equipped with a motorized opener.

While various spatial and directional terms, such as top, bottom, lower, mid, lateral, horizontal, vertical, front, and the like may be used to describe examples of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the examples disclosed and defined herein extend to all alternative combinations of two or more of the individual features mentioned or evident from the text and/or drawings. All of these different combinations constitute various alternative aspects of the present disclosure. The examples described herein explain the best modes known for practicing the disclosure and will enable others skilled in the art to utilize the disclosure. The claims are to be construed to include alternative examples to the extent permitted by the prior art.

What is claimed is:

1. A linear damper, comprising:
a rack including a connector;
a carriage slidably engaged with the rack;
a gear assembly between the carriage and the rack; and
a spring secured to the rack to urge the carriage away from the connector.

2. The linear damper of claim 1, wherein:
the carriage includes a spring pad, and
the spring selectively engages the carriage via the spring pad.

3. The linear damper of claim 1, wherein the spring extends partially along the rack.

4. The linear damper of claim 1, wherein the rack includes a stop tab to limit sliding motion of the carriage along the rack.

5. The linear damper of claim 4, wherein when the carriage contacts the stop tab, the spring is compressed.

6. The linear damper of claim 1, wherein the gear assembly drivably engages the rack and ratchetingly engages the carriage to selectively damp movement of the carriage along the rack.

7. The linear damper of claim 6, wherein the gear assembly rotates freely within the carriage when the carriage moves toward the connector.

8. The linear damper of claim 6, wherein a pawl teeth set of the gear assembly engages the carriage when the carriage moves away from the connector.

9. The linear damper of claim 8, wherein the pawl teeth set engages an internal notch of the carriage.

10. The linear damper of claim 1, wherein the gear assembly damps movement of the carriage along the rack when the carriage moves away from the connector.

11. The linear damper of claim 1, wherein the carriage slides freely along the rack when the carriage moves toward the connector.

12. The linear damper of claim 1, wherein:
the rack includes a gear teeth set,
the gear assembly includes a pinion, and
the pinion meshes with the gear teeth set.

13. The linear damper of claim 12, wherein the spring extends along an untoothed portion of the rack.

14. The linear damper of claim 1, wherein the connector is a first connector and the carriage includes a second connector.

15. The linear damper of claim 1, further comprising a switch mounted to the carriage, wherein the rack includes a switch tab to selectively engage the switch as the carriage moves along the rack.

16. A linear damper, comprising:
a rack including
a gear teeth set, and
an untoothed portion;
a carriage slidably engaged with the rack;
a gear assembly disposed in the carriage and slidably engaged with the rack; and
a spring extending along the untoothed portion to urge the gear assembly toward the gear teeth set.

17. The linear damper of claim 16, wherein:
the carriage includes a spring pad, and
the spring selectively engages the carriage via the spring pad.

18. The linear damper of claim 16, wherein the gear assembly damps movement of the carriage along the rack away from the spring.

19. A pivoting assembly, comprising:
a jamb;
a door pivotably engaged with the jamb; and
a linear damper connected to the jamb and the door, the linear damper including
a rack including an end,
a carriage slidably engaged with the rack,
a gear assembly between the carriage and the rack, and
a spring secured to the rack to urge the carriage away from the end.

20. The linear damper of claim 19, wherein the spring urges the door away from the jamb.
